(19) United States
(12) Patent Application Publication
(10) Pub. No.: US 2007/0216901 A1
(43) Pub. Date: Sep. 20, 2007

(54) Ellipsometry Device Provided With A Resonance Platform

(75) Inventors: Max Wiki, Ecublens (CH); Johannes Edlinger, Feldkirch (AT); Matthias Vaupel, Gottingen (DE); Andreas Eing, Gottingen (DE)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/572,284

(22) PCT Filed: Jul. 18, 2005
(86) PCT No.: PCT/EP05/07795

§ 371 Date: May 11, 2007

Related U.S. Application Data
(60) Provisional application No. 60/590,282, filed on Jul. 21, 2004.

(51) Int. Cl. G01J 4/00

(52) U.S. Cl. 356/369

(57) ABSTRACT

The invention relates to a useful improvement of an ellipsometer-type device. For this purpose, an existing ellipsometer is supplemented by a so-called resonance platform on which surface modes are excitable. Contrary to state of the art of known surface plasmons, the inventive modes are laterally localized. In addition, the resonance platform is not necessarily embodied in the form of a metal sheet. The inventive device also can be embodied in the form of an image-forming device. The inventive method consists in placing measurable samples on the platform surface and, afterwards, are exposed to light, thereby being excited in modes. The resonance position of modes is determined by the absorption behavior of a measurable substance.

### FIELD OF THE INVENTION

The invention relates to a system and a method for measuring the quantity, composition and/or spatial distribution and dynamics of substances on substrates.

### BACKGROUND OF THE INVENTION

It is common knowledge that the presence or the properties of substances on a surface can be determined by means of optical sensors. Of particular interest are imaging techniques designed to image a surface area with appropriate spatial resolution: Classic applications involve the imaging of reflection, transmission, absorption, scattered light or phase shifts. This may be accomplished at a given wavelength or by spectral dispersion. One important albeit variable parameter is the angle of incidence.

Particularly sensitive techniques utilize the effect of the surface on the polarization of the impinging light beam. Ellipsometry, for example, is a technique widely used in the analysis of thin films on substrates. It determines the ratio of the amplitude variation (Psi) of the s- and p-polarization after reflection as well as the relative phase shift (Delta) of the polarization components after reflection. To that effect, an ellipsometer encompasses, at least, means for projecting polarized light onto a sample and for measuring the light reflected or transmitted by the sample, in either case for s- and p-polarization. This permits the determination of the optical characteristics of the surface under analysis. Ellipsometry has been successfully employed for detecting the adsorption of proteins or smaller molecules on a surface. U.S. Pat. No. 4,508,832 by Carter et al describes the use of an ellipsometer for measuring antibody-antigen bonds in an immunoassay on a test surface.

Imaging ellipsometry, combining the capabilities of ellipsometry with those of microscopy, has been demonstrated with thin transparent films on silicon substrates. However, a single reflection yields a very marginal variation of the polarization characteristics, resulting in a signal detection with severe background noise. Another potential drawback is that the light propagates through the surrounding medium, especially in applications in which the optical characteristics of the surroundings may change while the measurement is in progress.

The problematic effect of the surrounding medium can be largely circumvented by using an optically transparent substrate and employing the principle of total internal reflection (TIR). U.S. Pat. No. 6,594,011 by Kempen describes a measuring system encompassing a light-source assembly, a total-reflection assembly and a detection assembly. In its application, the substrate with the substance under analysis is configured as a total-reflection layer system. This means that the surface on which the substance under analysis is positioned constitutes the interface between two transparent layers whose relative refractive indices are selected in such fashion that the light coupled into one of the transparent layers above the so-called critical angle is totally reflected by one of the interfaces that represents the substance under analysis. Those skilled in the art are familiar with the mechanisms of total reflection. Total reflection leads to changes in the polarization characteristics of incident light. Once the polarization characteristics of the incident light are known, an analysis of the polarization characteristics of the reflected light provides an indication of the properties and in particular of the mass distribution and/or film thickness of the substance under analysis on the substrate. In U.S. Pat. No. 6,594,011 the interaction of the light is limited to only one total reflection. As a result, the overall resolution of the measuring system is limited only by the resolving power of the detector array. In theory, any given high-resolution detector array could therefore perform the measurement with any desired spatial accuracy. But here again, a single total reflection would yield a very marginal variation of the polarization characteristics, producing a signal with severe noise interference.

One way to enhance the signal and thus the system sensitivity is to combine ellipsometry with surface plasmon (SPR) technology. In conventional SPR methodology the reflected light is measured as a function of the angle of incidence. At the so-called resonance angle, surface plasmons are energized to result in a strongly evanescent field in the surface area and in a sharply reduced reflection. The reflection minimum concomitant with surface plasmon excitation is shifted when a substance is adsorbed on the substrate, i.e. when it forms a film and augments its thickness. The ellipsometer measures the ellipsometric parameters Psi and Delta. Psi will be analogous to the measuring signal by the classic SPR method, whereas Delta will provide additional information and will be able to manifest a strong resonance as a function of the angle of incidence. A drawback consists in the fact that the substrate on whose surface the plasmons are to be energized is a metal or has at least a metallic film. Yet in bioanalytical applications the use of metallic films is often undesirable since these films are difficult to make, especially in terms of reproducibility. In particular, the longevity of metallic films is often quite limited.

Since the resolving power of the detector array itself is limited in physical and technical terms it is possible to use a total reflection system providing multiple reflections. At a minimum angle that permits total reflection, light is coupled into a highly refractive layer and totally reflected several times over before exiting the layer. The distance between the coupling and decoupling of the light is selected in such fashion that the range of multiple total reflection matches the resolving power of the detector array. The thickness of the layer is so selected as to cause the light to be totally reflected before exiting the layer. By virtue of the configuration of the total reflection system, the area around each data point corresponding to the resolving power of the detection device will develop a multiple interaction between the evanescent field of the input-coupled light and the layer under analysis. Those skilled in the art refer to this configuration as an asymmetric waveguide. The input coupling into a waveguide of this type is a typical optical resonance phenomenon. The multiple total reflection is referred to as wave conductance. Wave conductance only takes place above a certain layer thickness and only subject to certain (resonance) angles. The attendant light propagation is known as waveguide modes. If, on the other hand, the layer thickness is below a so-called cut-off value, there will be no multiple total reflection in the asymmetric waveguide since a mode can no longer be accommodated. The path traveled by the light in the waveguide within a zigzag cycle corresponds inversely to the propagation constant. For a typical waveguide layer with a refractive index of Ns=2.2 on glass having a refractive index of Ng=1.5 and at a wavelength under vacuum of 633 nm the cut-off thickness will be 200 nm. In that case the light will propagate just above the total reflection angle between the glass and the layer. Obtaining a two-time total reflection at the outer interface thus requires a propagation of more than 400 nm. 11 total reflections already make it 4 μm, substantially limiting the resolving power.

### OVERVIEW OF THIS INVENTION

It is therefore the objective of this invention to introduce a corresponding system operating on the basis of the locally resolved detection of the variations in the photonic characteristics within the range of optical resonance in a manner whereby the quality of the detected signal is enhanced and, in particular, improved resolving power is obtainable.

This objective is achieved in that the system according to the invention encompasses a resonance platform so configured as to permit the excitation of laterally localized resonances.

Another objective of this invention is to introduce a corresponding method based on the locally resolved detection of the variations in the photonic characteristics within the range of optical resonance in a manner whereby the quality of the detected signal is enhanced and, in particular, improved resolving power is obtainable.

This objective is achieved in that, according to the method, light impinges on a resonance platform with parameters that lead to the excitation of laterally localized resonances.

Accordingly, the invention covers a system for conducting ellipsometric measurements, encompassing an ellipsometer and a resonance platform, said resonance platform incorporating means which, when light impinges on the ellipsometer, are capable of exciting laterally localized resonant modes.

For example, the means incorporated in the resonance platform may include a resonant grating whose grating period is of an order of magnitude that corresponds to the wavelength of the light emitted by the light source of the ellipsometer.

The resonance platform with the resonant grating may include a transparent substrate that is coated with at least one dielectric layer, with the resonant grating positioned in that layer or on at least one of the interfaces delimiting that layer.

For performing the measurements it may be desirable for the resonance platform within the system to be supported in a manner whereby it can be rotated relative to the plane of incidence of the light of the ellipsometer around an axis that extends perpendicular to the surface of the resonance platform, and locked in its rotated position.

The system of the type described above may encompass an imaging ellipsometer.

According to the invention, the adsorption or desorption of substances on a surface can be measured in the following manner:
Provision of an ellipsometer
Provision of a substrate with a surface resonating to laterally localized modes
Application on the surface of a medium enveloping the substance to be measured
Excitation of laterally localized modes by causing polarized light to impinge on the resonance platform
Determination of the position of the resonance curve as a function of at least one excitation parameter.

To provide a reference, the position of the resonance curve, as the surface makes contact with the medium, may additionally be determined without the substance that is to be measured.

If an imaging process is employed, the position of the reference curve can be determined with local spatial resolution. It will thus be possible to process the detected locally resolved positional data into an image.

It will be advantageous to identify PSI and/or DELTA, the parameters typically used in ellipsometry, with PSI indicating the ratio of the amplitude variation of the s- and p-polarization after the reflection and DELTA indicating the relative phase shift (Delta) of the polarization components after the reflection.

The process can be optimized by using a conical light beam for exciting laterally localized modes.

The following discussion will cover both the inventive system and the inventive method.

For the purpose of this patent application, surface plasmons (SPR) are not considered to be laterally localized resonances since they usually propagate over several micrometers. Therefore, it is not possible to excite closely neighboring resonances as would be required for achieving high resolution.

For the purpose of this patent application, the term laterally localized resonance refers to any optical resonance other than a plasmon resonance and which, at a maximum, essentially limits the resonant interaction with the surface to an area whose order of magnitude compares to that of traditional total reflection known to those skilled in the art as the Goos-Hänchen effect.

The laterally localized resonance phenomena include, among others, the so-called evanescent resonance that is attainable for instance by means of resonant gratings. The grating period of resonant gratings is of a magnitude corresponding to the light used for exciting the resonance. The structures which in existing literature are referred to as photonic band gap structures, when propagated, lead to extremely loss-intensive and thus localized modes with a high-level field on the surface, as discussed in detail for instance in “Localisation of One Photon States” by C. Adlard, E. R. Pike Sarkar in Physical Review Letters, Vol. 79, No. 9, pages 1585-87 (1997). The resonance of some of the evanescent resonators reveals abnormally high reflection or transmission. One such structure with abnormally high reflection has been disclosed in patent application WO2001002839. Special mention must be made of the fact that this structure has been successfully employed in the realm of fluorescence analysis. In contrast to traditional waveguide structures this particular grating structure offers an advantage in that the impinging light shows almost no propagation in the high-refraction layer.

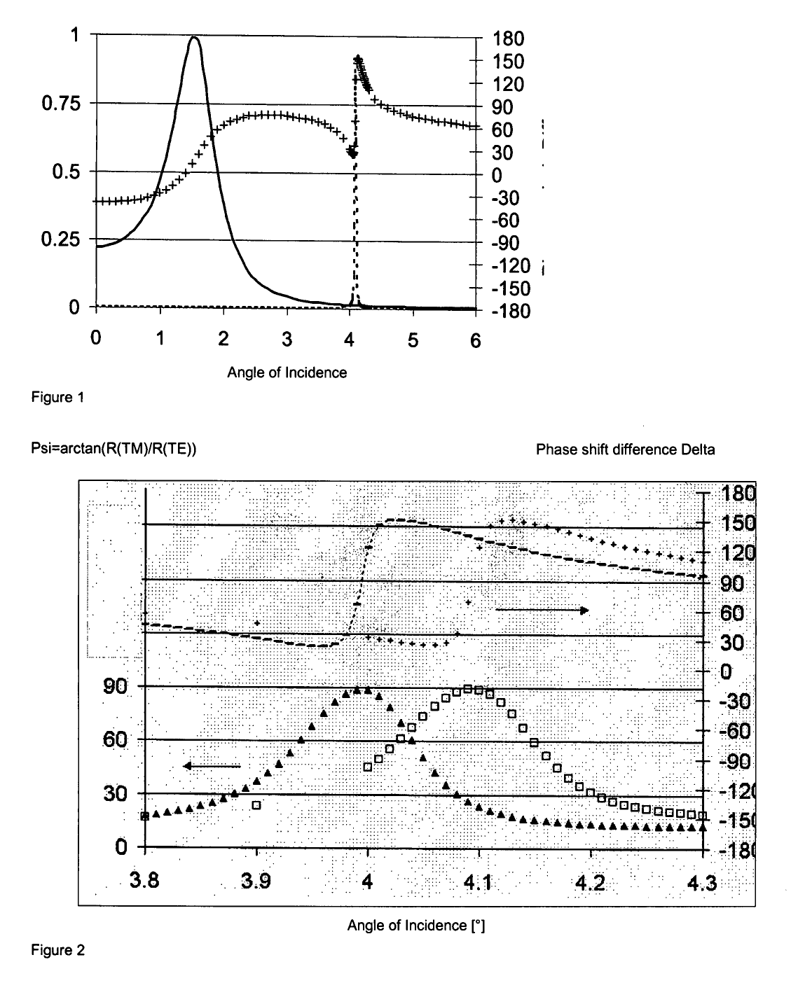

The structure discussed in this context as an example is assumed to include a glass substrate (plastic as well will serve the purpose) with a refractive index of ns=1.52, provided on one of its surfaces with a blazed periodic surface grating (grating period p=360 nm, rugate depth 40 nm, ridge-to-valley ratio 1:1). That surface is coated with a Ta₂O₅ layer 150 nm thick (refractive index nf=2.1 (other coating materials, with appropriately selected parameters, may also be used, such as TiO₂, Nb₂O₃ and others). When constructing for instance a layered system, the materials do not have to be of the highly refractive type. The grating on the glass surface replicates itself on the surface of the Ta₂O₅ layer. In the example, the medium next to the layer is assumed to be water (nc=1.33). When light of a wavelength of 633 nm impinges on this structure at an angle of incidence from 0° to 6°, with the plane of incidence delineated by the grating vector and the surface normal (non-conical incidence), the result per graph 1 will be the reflection for TE polarization (electric field vector perpendicular to the plane of incidence) shown as a dashed line and for TM polarization (electric field vector perpendicular to the plane of incidence) shown as a solid line. What counts for both is the left Y-axis (reflection 1 corresponds to 100%). Also illustrated is the phase difference of the phase shift in reflection which corresponds to the Delta variable known in ellipsometry (cross-hatched). There it is the right Y-axis that counts. As can be seen, there is a strong variation in the 4° to 4.6° range for the reflection TM as well as for Delta. Of particular interest is the steep slope of Delta as a function of the angle of incidence since in traditional ellipsometry it is this slope that determines the resolving power of the measuring system, i.e. it determines the smallest film thickness variation that can still be measured. In conventional ellipsometry there is a functional dependence that does not apply to resonant gratings. However, the inventors have come to realize that by means of theoretical simulation an association of the Delta curve shift can be ascertained, permitting on the basis of the Delta curve a very precise determination of the variation in the film thickness. For the biological substances considered on the premise of this patent application, whose adsorption on the surface is to be determined, it is assumed in the first example, for the sake of simplicity, that their refractive index corresponds to that of the coating material. Any biological deposits on the surface will essentially constitute an augmentation of the layer thickness. A closer examination allows the assumption of a biology-specific index in due consideration of the deposition on the ridge walls. In principle, however, this will not change the effect in any way. In the range from 3.8° to 4.3° for two different thicknesses (101 nm and 100 nm), FIG. 2 shows the typical ellipsometric variables Psi=tan(R_{/TM}/R_{/TE}) and Delta. It becomes obvious that measurements are possible with a far finer resolution than a 1 nm deposit. The diagram suggests that a resolution of 0.1 nm is altogether feasible.

It will be helpful if in the angular range of significance for the measurement a reflection signal sufficiently strong for both polarizations is available (≧1% of the incident intensity). In that case the quotients needed for calculating the variables Delta and Psi can be properly established without encountering interference such as electronic background noise. In the example here described, the reflection for both TM and TE polarization in the angular range from 3.9° to 4.3° is greater than 1%. Establishing the quotients TM/TE ensures that for instance light-intensity fluctuations will average themselves out. Polarization verification will nevertheless be highly desirable.

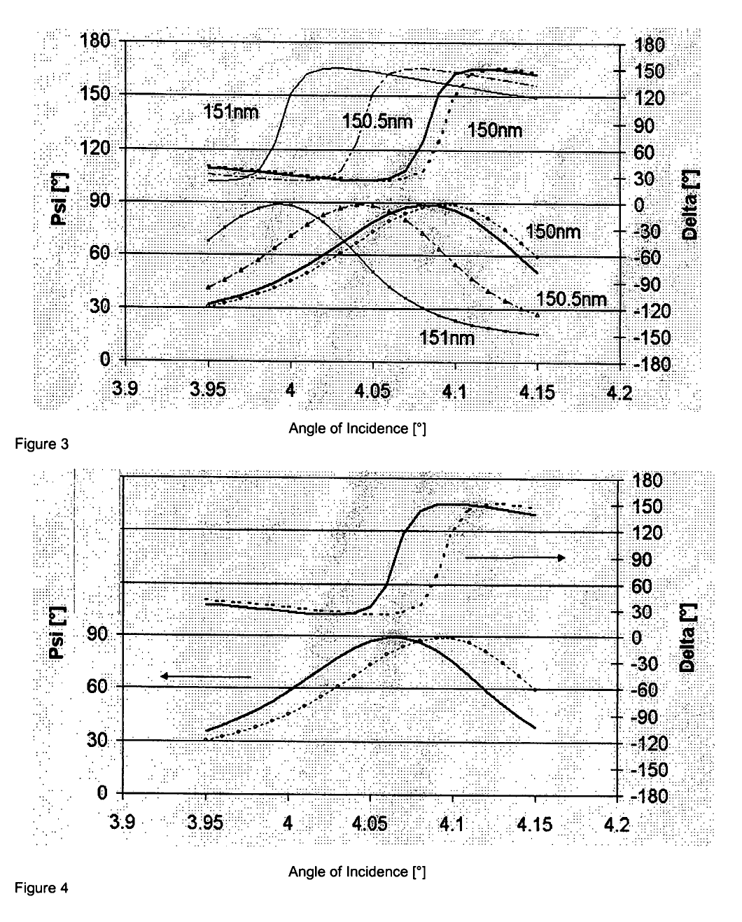

FIG. 3 again depicts the same Psi and Delta functions for 4 different layer thicknesses (150 nm, 150.1 nm, 150.5 nm and 151 nm). The bold lines represent the values for 150.1 nm. As will be evident, a resolution of 0.1 nm or better is entirely possible.

As has been mentioned above, a somewhat closer examination will allow for the precise biological index (nb=1.48) and the manner in which the material is adsorbed (covering the grating sidewalls as well) to be included in the equation. FIG. 4 shows Psi and Delta as a function of the angle of incidence for a structure covered with 1 nm of biological material (solid line) as well as the values without such coverage, i.e. the initial structure with a layer thickness of 150 nm (broken lines). Here as well it will be evident that a variation in the layer thickness can be measured with considerable accuracy.

It would have been equally possible to investigate the quotient of the resonances in the angular range from 0° to 2°. In that case, however, the reflection signal of the TM polarization is at about 0.35% and establishing a quotient becomes a rather critical task. It is better to use the absolute signal of the TE polarization. In this angular range, DELTA as well displays characteristics that shift as the film thickness is increased. Still, neither one is very steep and therefore cannot deliver the same resolution.

The method discussed lends itself very well to imaging ellipsometry. It permits a substrate according to the invention as described above to be analyzed for adsorbed material in spatially resolved fashion without markers. Since no physical contact is required, it is also possible to perform dynamics measurements.

As explained at the outset, essentially any type of laterally localized optical resonance phenomenon qualifies. Therefore, the scope of this invention is not limited to the resonant gratings with a reflection anomaly as discussed above in detail.

Up to this point the discussion has been limited to the concept of a non-conical light beam. The term non-conical light refers to a light beam impinging on a plane of incidence that extends perpendicular to the grooves, i.e. the grating vector is positioned in the plane of incidence. When the grating vector is rotated out of the plane of incidence, the result is a conical light beam. The inventors have discovered that a conical beam can be advantageously employed in the implementation of this invention. It is important to note that the angle of resonance will change by the amount of angular grating rotation, i.e. by the angular value by which the grating vector is rotated out of the plane of incidence. As has been stated above, the Delta slope is the limiting factor for the measuring precision. The following table will show the established dependence of the Delta slope on the angle of grating rotation. In the last column that value is translated into sensitivity.

| Angle of | Resonance Angle | Measured Delta | Calculated |
|---|---|---|---|
| Grating Rotation | of Incidence | Slope δΔ/δφ | Sensitivity |
| O [°] | φ [°] | in resonance | [pg/mm²] |
| 10 | 33.5 | 200 | 1 |
| 15 | 29.3 | 330 | 0.65 |
| 20 | 25.6 | 430 | 0.5 |

The most diverse resonant grating geometries displaying resonances can be employed. So can two-dimensional gratings having for instance a different grating period in the x- and y-direction. Structures of particular interest are those that produce a resonance at very small angles of incidence. It would be conceivably possible to upgrade an otherwise conventional fluorescence scanner for the ellipsometric method. Of course, there already exist fluorescence scanners that allow for a selection of the angle of incidence (for example Tecan), in which case as well an upgrade to the marker-free method described above should be feasible.

Summarizing, it can be stated that the sensitivity attainable with this invention matches that of a full SPR measurement. As has been mentioned, it is possible to adjust the sensitivity to a desired value by rotating the grating. This does not require any complex accessories for instance to apply an electrical field in the case of a tunable SPR sensor [patent DE 100 19 359]. Unlike SPR, it is not necessary to input-couple the light beam through a prism using immersion oil. Equally avoided is the use of a metal film. The drawback of metal films lies in the fact that thiol must be used to activate the biological bonding partner materials and that the optical properties of gold film are not adequately reproducible. Without metal and without immersion oil, the process is significantly simplified and accelerated.

For the quantitative determination of the thickness of a reaction layer on an SPR sensor it is necessary to establish the parameters thickness, index and extinction of the gold film on every sensor prior to the kinetics since these parameters generally vary between production lots. No such problem is encountered with the resonance platform. This means that, compared to SPR, the resonance platform offers the advantage, for instance in reaction kinetics, of allowing layer thicknesses on the Ta₂O₅ to be measured with less of a measuring investment yet with greater accuracy.

The simultaneous multi-channel acquisition of the reaction kinetics is equally possible on the grating coupler as is customary with an imaging SPR on an SPR sensor. The process involves the registration of the Delta variation during a change in the layer thickness at a constant angle of incidence, from which the layer-thickness kinetics can be determined.

1. System for performing ellipsometric measurements, encompassing an ellipsometer and a resonance platform, said resonance platform provided with means which permit laterally localized resonant modes to be excited when light impinges on the ellipsometer.

2. System as in claim 1, characterized in that the said means include a resonant grating whose grating period is of a magnitude corresponding to the wavelength of the light emitted by the light source of the ellipsometer.

3. System as in claim 2, characterized in that the resonance platform includes a transparent substrate that is coated with at least one dielectric layer and that the resonant grating is provided in said layer or on at least one interface delineating that layer.

4. System as in one of the claims 1 to 3, characterized in that within the system the resonance platform is supported in a manner whereby it can rotate, relative to the plane of incidence of the ellipsometer light, around an axis extending perpendicular to the surface of the resonance platform and can be locked in a rotated position.

5. System as in one of the preceding claims, characterized in that the ellipsometer is an imaging ellipsometer.

6. Method for measuring the adsorption or desorption of substances on a surface, comprising the following steps:
Provision of an ellipsometer
Provision of a substrate with a surface resonating to laterally localized modes
Application on the surface of a medium enveloping the substance to be measured
Excitation of laterally localized modes by causing polarized light to impinge on the resonance platform
Determination of the position of the resonance curve as a function of at least one excitation parameter.

7. Method as in claim 6, characterized in that, as a reference when the surface makes contact with the medium, the position of the resonance curve is determined without the substance that is to be measured.

8. Method as in claim 6 or 7, characterized in that the position of the reference curve is determined with local spatial resolution.

9. Method as in claim 8, characterized in that the detected locally resolved positional data area processed into an image.

10. Method as in one of the claims 6 to 9, characterized in that the PSI and/or DELTA parameters typically utilized in ellipsometry are determined, where PSI indicates the ratio of the amplitude variation of the s- and p-polarization after reflection and DELTA indicates the relative phase shift (Delta) of the polarization components after reflection.

11. Method as in one of the claims 6 to 10, characterized in that a conical light beam is used to excite laterally localized modes.
